(19) United States
(12) Patent Application Publication
(10) Pub. No.: US 2010/0176874 A1
(43) Pub. Date: Jul. 15, 2010

(54) VOLTAGE DETECTION CIRCUIT

(76) Inventors: Masakazu Sugiura, Chiba-shi (JP); Atsushi Igarashi, Chiba-shi (JP); Nan Kawashima, Chiba-shi (JP)

Correspondence Address: Brinks Hofer Gilson & Lione/Seiko Instruments Inc., P.O. Box 10395, Chicago, IL, 60611, US

(21) Appl. No.: 12/686,640

(22) Filed: Jan. 13, 2010

(30) Foreign Application Priority Data
Jan. 13, 2009 (JP) JP2009-004273

(51) Int. Cl. G05F 1/10

(52) U.S. Cl. 327/537; 327/535

(57) ABSTRACT

Provided is a voltage detection circuit having a small circuit scale. A P-type metal oxide semiconductor (PMOS) transistor (11) has an absolute value (Vtp) of its threshold voltage, which is equal to a minimum operating voltage. If a power supply voltage (VDD) becomes higher than the minimum operating voltage, the PMOS transistor (11) is turned ON to allow a current to flow therethrough. As a result, based on the current, an output voltage (Vout) is generated across a capacitor (15).

### RELATED APPLICATIONS

This application claims priority under 35 U.S.C. §119 to Japanese Patent Application No. 2009-004273 filed on Jan. 13, 2009, the entire content of which is hereby incorporated by reference.

### BACKGROUND OF THE INVENTION

1. Field of the Invention

The present invention relates to a voltage detection circuit for detecting a minimum operating voltage which allows a circuit to operate.

2. Description of the Related Art

Description is given of a conventional voltage detection circuit. FIG. 11 is a diagram illustrating the conventional voltage detection circuit.

In the voltage detection circuit, while a P-type metal oxide semiconductor (PMOS) transistor 93 is turned ON by a signal 10, a capacitor 95 is charged by the PMOS transistor 93.

A power supply voltage VDD is divided by a voltage divider circuit 91 into a divided voltage Vfb. A comparator 92 compares the divided voltage Vfb with a reference voltage Vref. If the divided voltage Vfb becomes lower than the reference voltage Vref, that is, if the power supply voltage VDD becomes lower than a predetermined voltage value, an output signal RST of the comparator 92 becomes “High” so that the voltage detection circuit may reset a target circuit (not shown) as a target.

Specifically, if the output signal RST becomes “High” as described above, an N-type metal oxide semiconductor (NMOS) transistor 94 is turned ON. Then, the capacitor 95 is discharged, and accordingly an output signal RSTX becomes “Low” so that the voltage detection circuit may reset the target circuit as a target (see, for example, JP 2007-318770 A (FIG. 14)).

In the conventional technology, the power supply voltage VDD is monitored by the voltage divider circuit 91 and the comparator 92, and hence there is a problem that a circuit scale of the voltage detection circuit is increased correspondingly.

### SUMMARY OF THE INVENTION

The present invention has been made in view of the above-mentioned problem, and provides a voltage detection circuit having a small circuit scale.

In order to solve the above-mentioned problem, the present invention provides a voltage detection circuit for detecting a minimum operating voltage which allows a target circuit as a target to operate, the voltage detection circuit including: a transistor having an absolute value of a threshold voltage, which is set based on the minimum operating voltage, the transistor being turned ON to allow a current to flow therethrough if a power supply voltage becomes higher than the minimum operating voltage; and a capacitor across which an output voltage is generated based on the current.

According to the present invention, instead of using circuits such as a voltage divider circuit and a comparator for monitoring a power supply voltage, the power supply voltage is monitored by the transistor, which results in a reduced circuit scale of the voltage detection circuit.

### BRIEF DESCRIPTION OF THE DRAWINGS

In the accompanying drawings:

FIG. 1 is a circuit diagram illustrating a voltage detection circuit according to the present invention;

FIG. 2 is a time chart illustrating an output voltage of the voltage detection circuit according to the present invention;

FIG. 3 is another time chart illustrating the output voltage of the voltage detection circuit according to the present invention;

FIG. 4 is a circuit diagram illustrating another example of the voltage detection circuit according to the present invention;

FIG. 5 is a circuit diagram illustrating further another example of the voltage detection circuit according to the present invention;

FIG. 6 is a circuit diagram illustrating still another example of the voltage detection circuit according to the present invention;

FIG. 7 is a time chart illustrating an output voltage of the voltage detection circuit of FIG. 6;

FIG. 8 is another time chart illustrating the output voltage of the voltage detection circuit of FIG. 6;

FIG. 9 is a circuit diagram illustrating yet another example of the voltage detection circuit according to the present invention;

FIG. 10 is a circuit diagram illustrating yet another example of the voltage detection circuit according to the present invention; and

FIG. 11 is a circuit diagram illustrating a conventional voltage detection circuit.

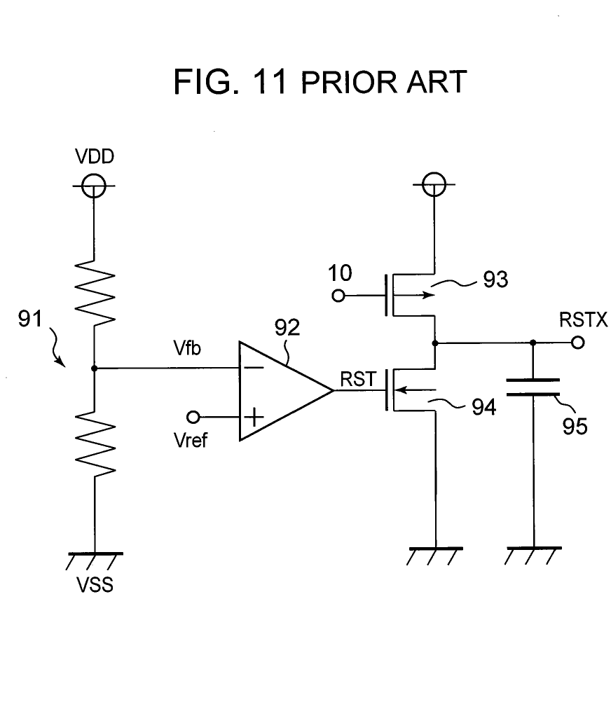

### DETAILED DESCRIPTION OF THE PREFERRED EMBODIMENTS

Now, referring to the accompanying drawings, an embodiment of the present invention is described.

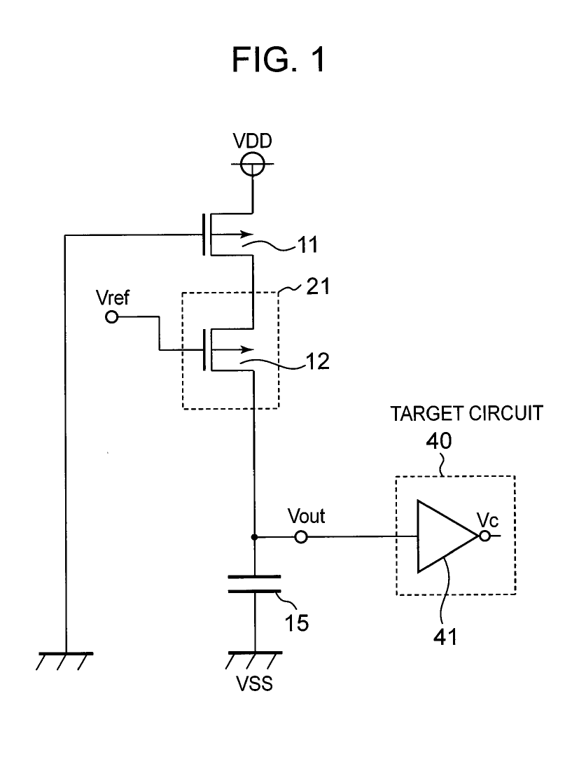

First, description is given of a configuration of a voltage detection circuit for detecting a minimum operating voltage which allows a target circuit as a target to operate. FIG. 1 is a circuit diagram illustrating a voltage detection circuit according to the present invention.

The voltage detection circuit includes a P-type metal oxide semiconductor (PMOS) transistor 11, a current source 21, and a capacitor 15. The current source 21 includes a PMOS transistor 12. A target circuit 40 having an input terminal connected to an output terminal of the voltage detection circuit includes, for example, an inverter 41.

The PMOS transistor 11 has a gate connected to a ground terminal, a source connected to a power supply terminal, and a drain connected to a source of the PMOS transistor 12. The PMOS transistor 12 has a gate connected to a reference voltage input terminal, and a drain connected to the output terminal of the voltage detection circuit. The capacitor 15 is provided between the output terminal of the voltage detection circuit and the ground terminal. The inverter 41 has an input terminal connected to the output terminal of the voltage detection circuit, and an output terminal connected to a circuit (not shown).

The voltage detection circuit operates based on a power supply voltage VDD and a ground voltage VSS. An output voltage Vout is generated across the capacitor 15. The inverter 41 outputs a voltage Vc based on the output voltage Vout.

The PMOS transistor 12 has the gate applied with a reference voltage Vref, and functions as a current source. In addition, the PMOS transistor 12 limits a current flowing through the PMOS transistor 11 to a drive current of the PMOS transistor 12. The PMOS transistor 11 has an absolute value Vtp of its threshold voltage, which is equal to the minimum operating voltage. If the power supply voltage VDD becomes higher than the minimum operating voltage, the PMOS transistor 11 is turned ON to allow a current to flow therethrough, and then the PMOS transistor 12 (current source 21) charges the capacitor 15. As a result, based on the current, the output voltage Vout is generated across the capacitor 15.

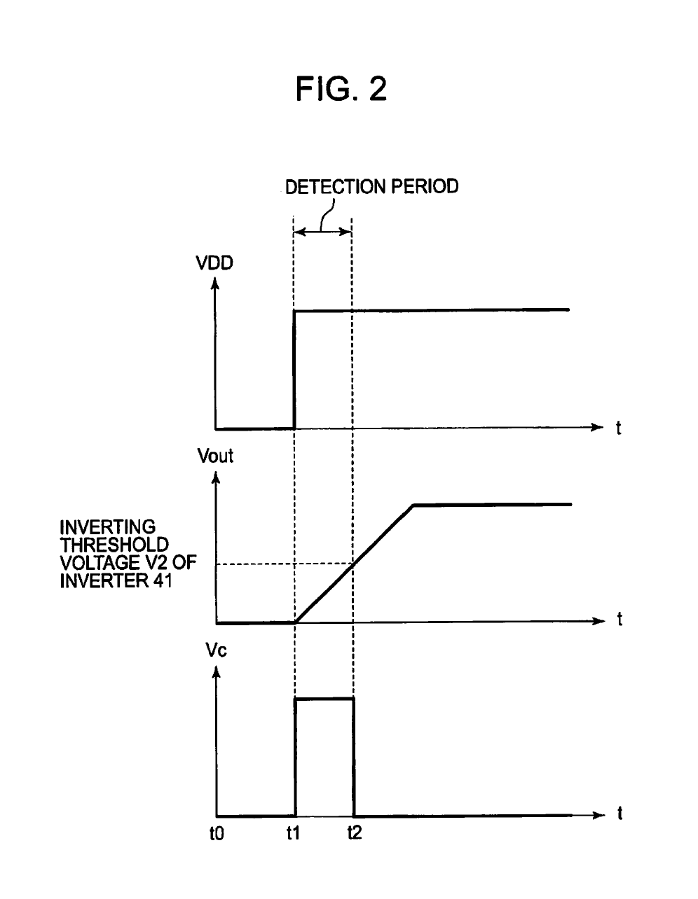

Next, description is given of an operation of the voltage detection circuit in a case where the power supply voltage VDD rises steeply. FIG. 2 is a time chart illustrating an output voltage of the voltage detection circuit according to the present invention.

If t0≦t<t1, the power supply voltage VDD does not yet rise at all, and hence the output voltage Vout and the voltage Vc are equal to the ground voltage VSS.

If t=t1 (at the time of detection), the power supply voltage VDD rises steeply. Then, a gate-source voltage of the PMOS transistor 11 becomes higher than the absolute value Vtp of the threshold voltage of the PMOS transistor 11, with the result that the PMOS transistor 11 is turned ON, thereby being capable of detecting that the power supply voltage VDD becomes higher than the minimum operating voltage. Besides, at this time, because the reference voltage Vref is stable, the PMOS transistor 12 is also turned ON to function as the current source. Thus, the PMOS transistor 12 starts to charge the capacitor 15. However, at this time, the output voltage Vout remains equal to the ground voltage VSS, and hence the voltage Vc becomes “High”.

If t1<t<t2 (during a detection period), because the PMOS transistor 12 is charging the capacitor 15, the output voltage Vout increases gradually. The output voltage Vout at this time is “Low” with respect to the inverter 41, and the voltage detection circuit utilizes this signal of “Low” to detect that the power supply voltage VDD is higher than the minimum operating voltage and to notify the target circuit 40 of the detection. In other words, the voltage detection circuit resets the target circuit 40. Further, because the output voltage Vout is “Low” with respect to the inverter 41, the voltage Vc is “High” and equal to the power supply voltage VDD.

The detection period of this case is determined based on each of the driving capability of the PMOS transistor 12, a capacitance and a leakage current of the capacitor 15, and an inverting threshold voltage V2 of the inverter 41.

If t=t2, the output voltage Vout becomes higher than the inverting threshold voltage V2 of the inverter 41, and then the voltage Vc becomes “Low”. The output voltage Vout at this time is “High” with respect to the inverter 41, and the voltage detection circuit no longer notifies the target circuit 40 that the power supply voltage VDD is higher than the minimum operating voltage.

After that, although not illustrated, if the power supply voltage VDD falls, due to the leakage current of the capacitor 15, the output voltage Vout is discharged to be equal to the ground voltage VSS. On this occasion, the voltage detection circuit is allowed to notify again the target circuit 40 that the power supply voltage VDD is higher than the minimum operating voltage, as long as after the power supply voltage VDD has risen once and fallen thereafter, a discharge time period required for the discharge due to the leakage current of the capacitor 15 has elapsed, and then the power supply voltage VDD has risen once again. In other words, a timing at which power supply becomes possible again is determined based on the discharge time period.

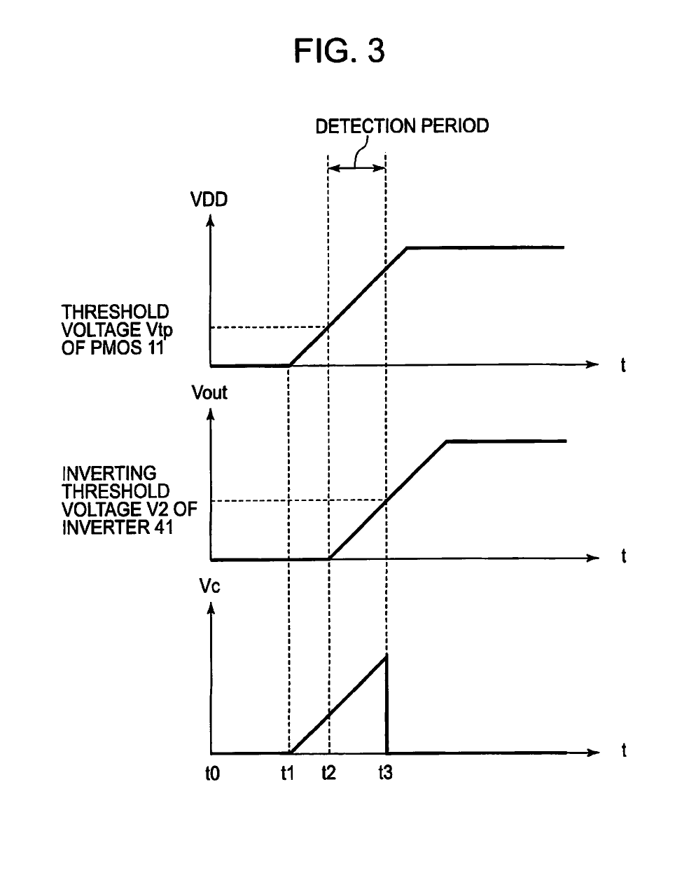

Next, description is given of an operation of the voltage detection circuit in a case where the power supply voltage VDD rises gradually. FIG. 3 is a time chart illustrating an output voltage of the voltage detection circuit according to the present invention.

If t0≦t<t1, the power supply voltage VDD does absolutely not rise yet, and hence the output voltage Vout and the voltage Vc are equal to the ground voltage VSS.

If t1<t<t2, the power supply voltage VDD rises gradually. On this occasion, the output voltage Vout is “Low” while the voltage Vc is “High”, and hence the voltage Vc also increases gradually.

If t=t2 (at the time of detection), the power supply voltage VDD increases and the gate-source voltage of the PMOS transistor 11 becomes higher than the absolute value Vtp of the threshold voltage of the PMOS transistor 11. Accordingly, the PMOS transistor 11 is turned ON, and the power supply voltage VDD is detected to have become higher than the minimum operating voltage. Besides, at this time, because the reference voltage Vref is stable, the PMOS transistor 12 is also turned ON to function as the current source. Then, the PMOS transistor 12 starts to charge the capacitor 15. However, the output voltage Vout remains equal to the ground voltage VSS at this time, and hence the voltage Vc remains “High”.

If t2<t<t3 (during a detection period), because the PMOS transistor 12 is charging the capacitor 15, the output voltage Vout increases gradually. The output voltage Vout at this time is “Low” with respect to the inverter 41, and the voltage detection circuit utilizes this signal of “Low” to detect that the power supply voltage VDD is higher than the minimum operating voltage and to notify the target circuit 40 of the detection. In other words, the voltage detection circuit resets the target circuit 40. Further, because the output voltage Vout is “Low” with respect to the inverter 41, the voltage Vc is “High” and follows the power supply voltage VDD.

If t=t3, the output voltage Vout becomes higher than the inverting threshold voltage V2 of the inverter 41, and then the voltage Vc becomes “Low”. The output voltage Vout at this time is “High” with respect to the inverter 41, and the voltage detection circuit no longer notifies the target circuit 40 that the power supply voltage VDD is higher than the minimum operating voltage.

With the configuration described above, instead of using circuits such as a voltage divider circuit and a comparator for monitoring the power supply voltage VDD, the PMOS transistor 11 monitors that the power supply voltage VDD becomes higher than the minimum operating voltage which allows the target circuit 40 as a target to operate (minimum operating voltage), which results in a reduced circuit scale of the voltage detection circuit.

Besides, in both the cases where the power supply voltage VDD rises steeply and where the power supply voltage VDD rises gradually, the detection period may be provided whose time period is determined based on each of the driving capability of the PMOS transistor 12, the capacitance and the leakage current of the capacitor 15, and the inverting threshold voltage V2 of the inverter 41. As a result, the voltage detection circuit is capable of monitoring that the power supply voltage VDD becomes higher than the minimum operating voltage.

Note that, although not illustrated, a diode or a MOS transistor having a diode connection may be provided between the power supply terminal and the source of the PMOS transistor 11. In this case, the minimum operating voltage corresponds to a total voltage of the absolute value of the threshold voltage of the PMOS transistor 11 and an absolute value of a threshold voltage of the diode or the MOS transistor having a diode connection.

Note that, although not illustrated, a diode or a MOS transistor having a diode connection may be provided between the gate of the PMOS transistor 11 and the ground terminal. In this case, the minimum operating voltage corresponds to a total voltage of the absolute value of the threshold voltage of the PMOS transistor 11 and an absolute value of a threshold voltage of the diode or the MOS transistor having a diode connection.

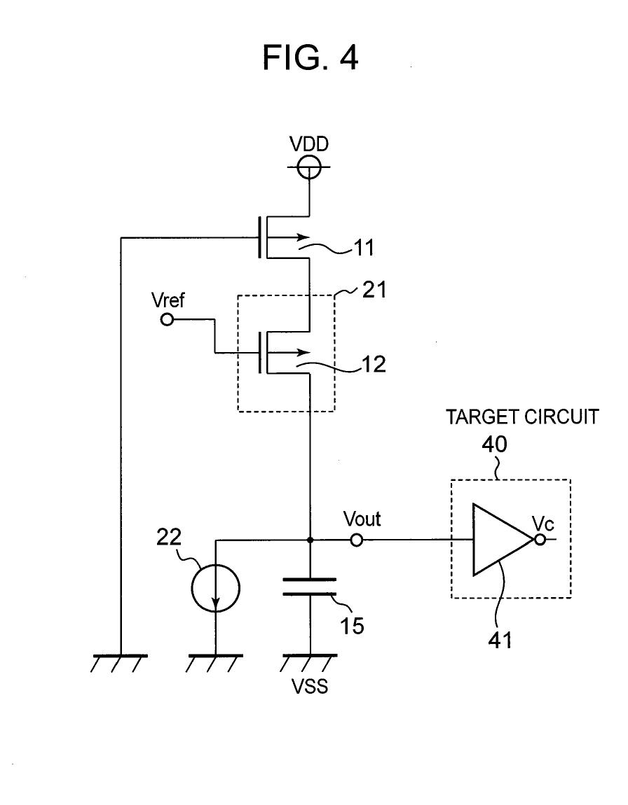

Alternatively, as illustrated in FIG. 4, a low impedance element 22 may be provided between the output terminal of the voltage detection circuit and the ground terminal. Examples of the low impedance element 22 include a current source and a resistor. In this case, the discharge time period is determined based on both of the leakage current of the capacitor 15 and a drive current of the low impedance element 22, not based on the leakage current of the capacitor 15 alone. Accordingly, the discharge time period is reduced correspondingly to the drive current of the low impedance element 22. For example, if possible instantaneous power failure occurs, the voltage detection circuit may have a discharge time period shorter than the instantaneous power failure time period. Therefore, even if the instantaneous power failure occurs, the discharge is completed during the instantaneous power failure, and hence the voltage detection circuit is allowed to notify again the target circuit 40 that the power supply voltage VDD is higher than the minimum operating voltage. In addition, if the power supply voltage VDD rises once and falls thereafter, owing to the low impedance element 22, the output voltage Vout may be discharged more securely to be equal to the ground voltage VSS more accurately.

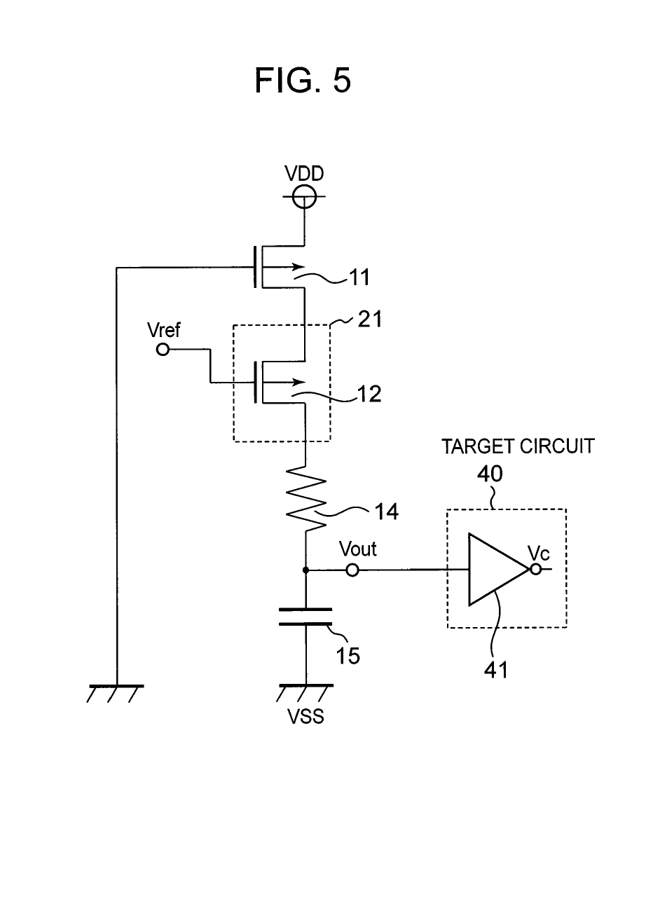

Further alternatively, as illustrated in FIG. 5, a resistor 14 may be provided between the PMOS transistor 12 and the output terminal of the voltage detection circuit. In this case, at the time of detection, the resistor 14 limits a current flowing through a current path extending from the power supply terminal to the ground terminal via the PMOS transistor 11, the PMOS transistor 12, the resistor 14, and the capacitor 15. As a result, an overcurrent is less likely to flow through the current path. Further, a parasitic capacitance (not shown) exists between a back gate of the PMOS transistor 12, which is affected by the power supply voltage VDD, and the drain of the PMOS transistor 12, which outputs the output voltage Vout, and hence if the resistor 14 is not provided, when the power supply voltage VDD fluctuates steeply due to noise and the like, the output voltage Vout may also fluctuate steeply due to the parasitic capacitive coupling therebetween. However, in the configuration illustrated in FIG. 5, the resistor 14 is provided so that the resistor 14 and the capacitor 15 may function as a low pass filter, which results in the reduced influence of the steep fluctuation in the power supply voltage VDD upon the output voltage Vout via the parasitic capacitance.

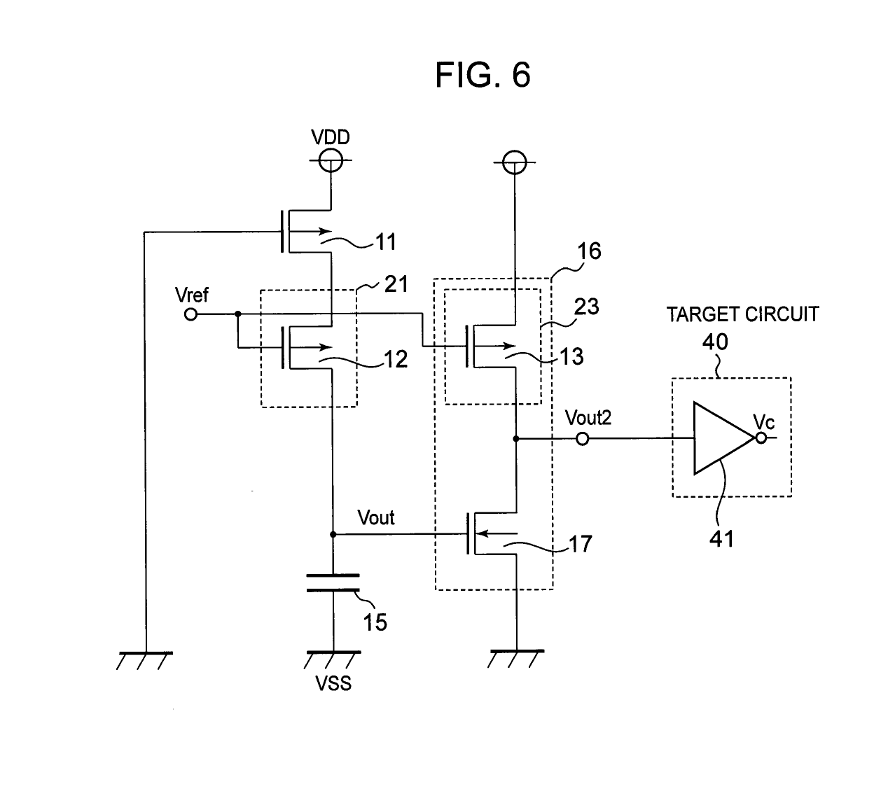

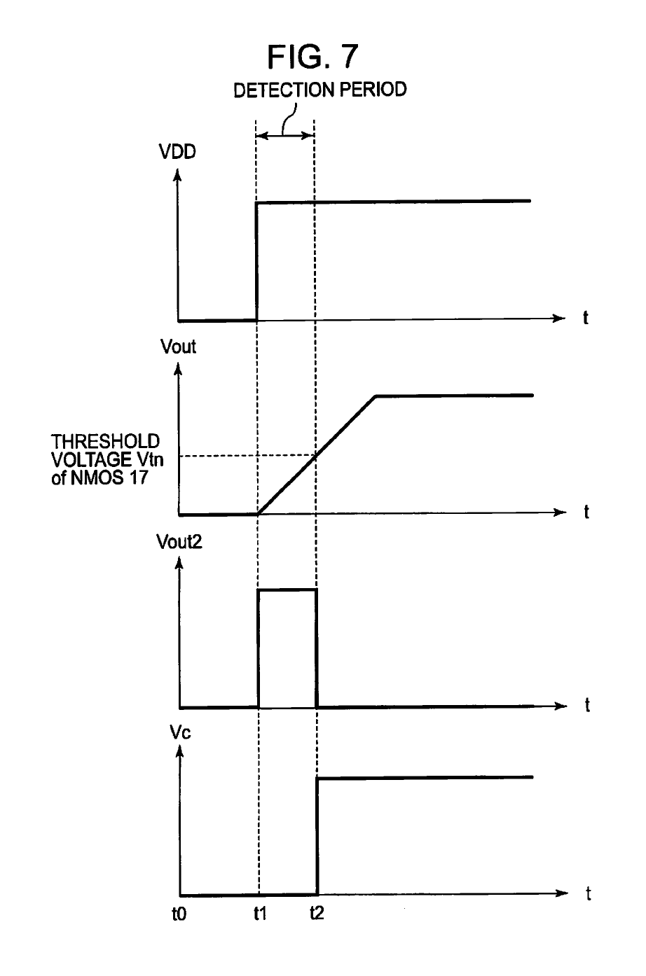

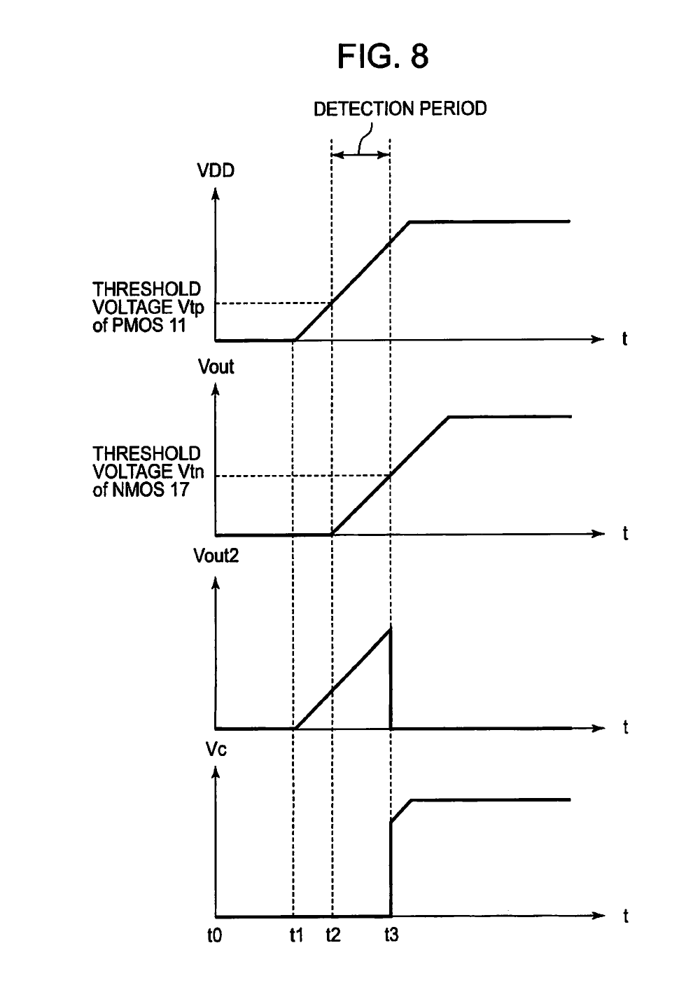

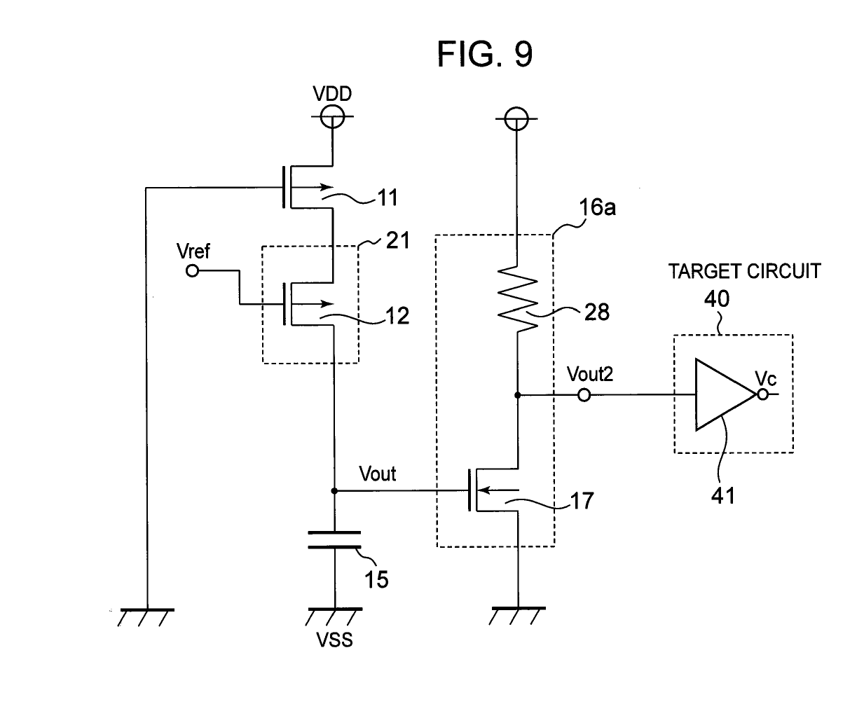

Still further alternatively, as illustrated in FIG. 6, an inverter 16 may be provided to the output terminal of the voltage detection circuit. The inverter 16 includes a current source 23 and an NMOS transistor 17. The current source 23 includes a PMOS transistor 13 that has a gate applied with the reference voltage Vref to function as a current source. In this case, an output voltage Vout2 illustrated in FIG. 7 corresponds to the voltage Vc illustrated in FIG. 2, and a voltage Vc illustrated in FIG. 7 becomes “High” if t=t2. Further, an output voltage Vout2 illustrated in FIG. 8 corresponds to the voltage Vc illustrated in FIG. 3, and a voltage Vc illustrated in FIG. 8 becomes “High” if t=t3. With this configuration, as illustrated for the output voltage Vout2 of each of FIG. 7 and FIG. 8, a one-shot pulse is generated inside the voltage detection circuit, resulting in improved convenience with respect to the target circuit 40 provided at a subsequent stage of the voltage detection circuit. In this case, an inverting threshold voltage V1 of the inverter 16 is equal to a threshold voltage Vtn of the NMOS transistor 17, and hence even if the power supply voltage VDD fluctuates, the inverting threshold voltage V1 of the inverter 16 does not fluctuate. As a result, even if the power supply voltage VDD fluctuates, the detection time period of the voltage detection circuit does not fluctuate. Note that as illustrated in FIG. 9, an inverter 16a may be provided to the output terminal of the voltage detection circuit. The inverter 16a includes a resistor 28 and the NMOS transistor 17.

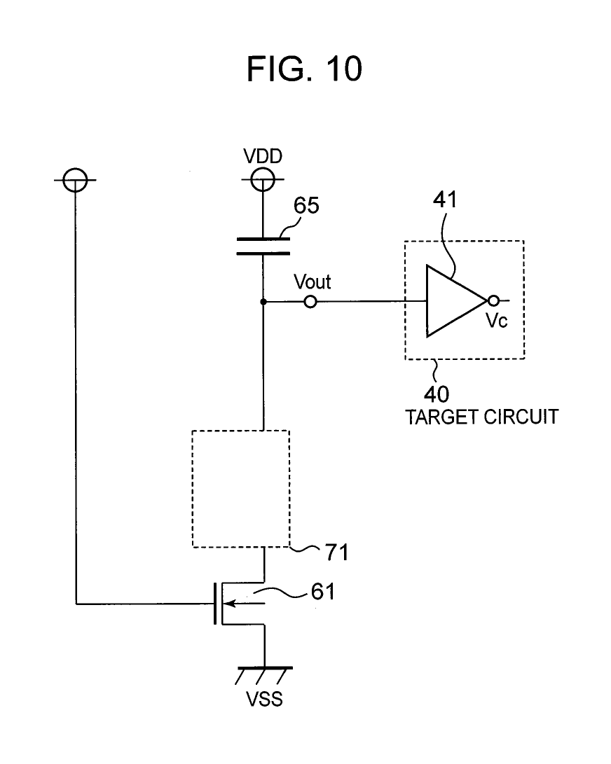

Note that in FIG. 1, the PMOS transistor 11, the current source 21, and the capacitor 15 are provided between the power supply terminal and the ground terminal in the stated order. Alternatively, as illustrated in FIG. 10, a capacitor 65, a current source 71, and an NMOS transistor 61 may be provided therebetween in the stated order. In this case, the NMOS transistor 61 has an absolute value Vtn of its threshold voltage, which is equal to the minimum operating voltage. When the power supply voltage VDD becomes higher than the minimum operating voltage, the NMOS transistor 61 is turned ON to allow a current to flow therethrough. As a result, based on the current, the output voltage Vout is generated across the capacitor 65.

In FIG. 1, the current source 21 is provided. Alternatively, although not illustrated, the current source 21 may be omitted. In this case, the current flowing through the PMOS transistor 11 directly charges the capacitor 15. As a result, circuit design is made such that a capacitance of the capacitor 15 is set based on the current flowing through the PMOS transistor 11 and the leakage current of the capacitor 15, to thereby attain a desired detection time period.

What is claimed is:

1. A voltage detection circuit for detecting a minimum operating voltage which allows a circuit to operate,
the voltage detection circuit comprising:
a transistor having an absolute value of a threshold voltage, which is equal to the minimum operating voltage,
the transistor being turned ON if a power supply voltage becomes higher than the minimum operating voltage;
a first current source, which allows a current to flow therethrough if the transistor is turned ON; and
a capacitor, which is charged with the current flowing through the first current source, and generates an output voltage at an output terminal of the voltage detection circuit.

2. A voltage detection circuit according to claim 1, further comprising a low impedance element for conducting one of charging and discharging the output voltage generated at the output terminal.

3. A voltage detection circuit according to claim 1, further comprising an inverter provided to the output terminal.

4. A voltage detection circuit according to claim 3, wherein the inverter comprises:
a second current source; and
an N-type metal oxide semiconductor (NMOS) transistor.

5. A voltage detection circuit according to claim 3, wherein the inverter comprises:
a second resistor; and
an NMOS transistor.

6. A voltage detection circuit according to claim 1, wherein the transistor comprises a P-type metal oxide semiconductor (PMOS) transistor, which comprises:
a gate connected to a ground terminal;
a source connected to a power supply terminal; and
a drain connected to the output terminal.

7. A voltage detection circuit according to claim 1, wherein the transistor comprises a PMOS transistor, which comprises:
a gate connected to a ground terminal;
a source connected to a power supply terminal via one of a diode and a MOS transistor having a diode connection; and
a drain connected to the output terminal.

8. A voltage detection circuit according to claim 1, wherein the transistor comprises a PMOS transistor, which comprises:
a gate connected to a ground terminal via one of a diode and a MOS transistor having a diode connection;
a source connected to a power supply terminal; and
a drain connected to the output terminal.

9. A voltage detection circuit according to claim 1, wherein the transistor comprises an NMOS transistor, which comprises:
a gate connected to a power supply terminal;
a source connected to a ground terminal; and
a drain connected to the output terminal.

10. A voltage detection circuit according to claim 1, wherein the transistor comprises an NMOS transistor, which comprises:
a gate connected to a power supply terminal;
a source connected to a ground terminal via one of a diode and a MOS transistor having a diode connection; and
a drain connected to the output terminal.

11. A voltage detection circuit according to claim 1, wherein the transistor comprises an NMOS transistor, which comprises:
a gate connected to a power supply terminal via one of a diode and a MOS transistor having a diode connection;
a source connected to a ground terminal; and
a drain connected to the output terminal.

12. A voltage detection circuit according to claim 1, further comprising a first resistor, which is provided between the transistor and the output terminal.
